(19) United States
(12) Patent Application Publication
(10) Pub. No.: US 2022/0111533 A1
(43) Pub. Date: Apr. 14, 2022

(54) END EFFECTOR CONTROL SYSTEM AND END EFFECTOR CONTROL METHOD

(71) Applicant: Panasonic Intellectual Property Management Co., Ltd., Osaka (JP)

(72) Inventors: Yuzuka ISOBE, Osaka (JP); Yoshinari MATSUYAMA, Osaka (JP); Tomoyuki YASHIRO, Osaka (JP); Kozo EZAWA, Osaka (JP)

(21) Appl. No.: 17/560,614

(22) Filed: Dec. 23, 2021

Related U.S. Application Data
(63) Continuation of application No. PCT/JP2020/021555, filed on Jun. 1, 2020.

(30) Foreign Application Priority Data
Jun. 27, 2019 (JP) 2019-120594

(51) Int. Cl. B25J 9/16; B25J 15/04; B25J 13/08

(52) U.S. Cl. CPC B25J 9/1697; B25J 15/08; B25J 13/08; B25J 15/0483

(57) ABSTRACT

An end effector control system that controls a plurality of end effectors connectable to a robot arm, the end effector control system including: an image acquisition unit that acquires an image of an end effector connected to the robot arm among the plurality of end effectors; an identification information acquisition unit that acquires identification information that identifies the end effector; a control unit that controls the end effector; and a memory having control information including a target position of each of the plurality of end effectors. The control unit acquires the identification information from the identification information acquisition unit, determines a target position of the end effector in accordance with the identification information and the control information, and controls the end effector to be located at the target position based on the image acquired by the image acquisition unit.

### BACKGROUND

### 1. Technical Field

The present disclosure relates to an end effector control system and an end effector control method.

### 2. Description of the Related Art

Patent literature (PLT) 1 discloses a robot control device that controls a robot device including a robot hand that grips a gripping target. This robot control device includes a first acquisition means for acquiring visual information of a gripping target, a second acquisition means for acquiring force sensory information acting on the gripping target by a robot hand, a calculation means for calculating a position and an attitude of the gripping target from the visual information acquired by the first acquisition means, a derivation means for deriving a gripping state variability of the gripping target based on the force sensory information acquired by the second acquisition means, and a control means for controlling at least one processing execution of the first acquisition means and the calculation means based on the gripping state variability of the gripping target derived by the derivation means.

PTL 1 is Unexamined Japanese Patent Publication No. 2017-87325.

### SUMMARY

The present disclosure has been made in view of the above-described conventional situations, and an object of the present invention is to provide an end effector control system capable of controlling an end effector while simplifying a robot hand, and an end effector control method therefor.

The present disclosure relates to an end effector control system that controls a plurality of end effectors connectable to a robot arm, the end effector control system including: an image acquisition unit that acquires an image of an end effector connected to the robot arm among the plurality of end effectors; an identification information acquisition unit that acquires identification information that identifies the end effector; a control unit that controls the end effector; and a memory having control information including a target position of each of the plurality of end effectors. The control unit acquires the identification information from the identification information acquisition unit, determines a target position of the end effector in accordance with the identification information and the control information, and controls the end effector to be located at the target position based on the image acquired by the image acquisition unit.

Further, the present disclosure relates to an end effector control method of controlling a plurality of end effectors connectable to a robot arm by a control system including an image acquisition unit, an identification information acquisition unit, and a memory, the end effector control method including: acquiring identification information that identifies each of the plurality of end effectors from the identification information acquisition unit; determining a target position of an end effector among the plurality of end effectors in accordance with the identification information and control information which is a target position of each of the plurality of end effectors stored in the memory; and controlling the end effector to be located at the target position based on an image acquired by the image acquisition unit.

Further, the present disclosure relates to an end effector control system for controlling an end effector connected to a robot arm, the end effector control system including a memory, a processor, and a camera. The camera is disposed at a position where the end effector and a workpiece which is a work target of the end effector can be imaged. The memory has feature point information indicating a feature point at a first support target position when the end effector supports the workpiece. The processor specifies a feature point at a current position of the end effector and a position of the workpiece based on an image captured by the camera, and controls the end effector to be located the feature point at the current position of the end effector at the feature point indicated by the feature point information.

According to the present disclosure, an end effector can be controlled while simplifying a robot hand.

### BRIEF DESCRIPTION OF DRAWINGS

FIG. 1 is a view showing a configuration example of robot arm 1 and end effector 2, the view including (a) a perspective view, (b) a side view, and (c) a plan view.

FIG. 2 is a view showing end effector 2 shown in FIG. 1, the view including (a) a plan view and (b) a perspective view.

FIG. 3 is a view showing an imaging range of a camera CAM connected to end effector 2.

FIG. 4 is a block diagram showing a hardware configuration example of control system 100.

FIG. 5 is a flowchart showing an initial setting example of control system 100.

FIG. 6 is a diagram showing feature point information table T stored in memory 102.

FIG. 7 is a flowchart showing an example in which control system 100 according to a first exemplary embodiment controls support (gripping) of workpiece W by end effector 2.

FIG. 8 is a diagram showing a control example of end effector 2 by control system 100 according to the first exemplary embodiment, the diagram including (a) a plan view at the start of operation, (b) a plan view at the completion of gripping, and (c) a conceptual diagram showing drive control of end effector 2 based on feature points.

FIG. 9 is a flowchart showing an example in which control system 100 according to a second exemplary embodiment controls support (gripping) of workpiece W by end effector 2.

FIG. 10 is a diagram showing a control example of end effector 2 by control system 100 according to the second exemplary embodiment, the diagram including (a) a plan view and a conceptual diagram at the start of operation, (b) a plan view and a conceptual diagram at the completion of gripping, and (c) a plan view and a conceptual diagram at the completion of re-gripping.

FIG. 11 is a diagram showing an example of support check in step St23 of FIG. 9, the diagram including (a) a flowchart showing an example of check based on an amount of movement, and (b) a plan view showing an example of check based on deformation of workpiece W.

### DETAILED DESCRIPTION

(Circumstances that have LED to the Present Disclosure)

A robot device for use in a factory or the like can perform various works by attaching an end effector to a robot arm. The work is, for example, picking parts flowing on a factory production line using a robot hand as an end effector. The robot arm and the end effector are controlled by a control device (controller) connected to the robot arm.

Conventionally, the above control has been performed by using feedback from various sensors such as an encoder and a force sensor. For example, also in the technique recited in PLT 1, variability of a gripping state of a gripping target (workpiece) is derived by using a force sensor.

However, at the time of starting up a robot arm and an end effector equipped with various sensors, it is necessary to calibrate each sensor, so that it takes time to set the sensor.

Further, in a case where a robot arm and an end effector are provided with a plurality of sensors, information obtained as feedback from the plurality of sensors also becomes a plurality of systems, so that information processing becomes complicated. Furthermore, in a case of control using artificial intelligence, data for causing the artificial intelligence to perform machine learning becomes multimodal, which is difficult to learn.

Therefore, in the following first and second exemplary embodiments, a shape of an end effector is recognized by a camera without using a force sensor or the like, and control is performed based on an image captured by the camera. With this configuration, it is not necessary to use other sensors in a control system. Therefore, calibration is required only for a camera, which facilitates calibration of the entire system. In other words, it is possible to make a simple system configuration without a sensor.

Further, in the above configuration without using a force sensor or the like, feedback information from an end effector can be aggregated in an image captured by a camera. In other words, multimodal information processing can be avoided. It is also beneficial to reduce the channels of information used also when artificial intelligence is made to perform machine learning.

In the following, exemplary embodiments in which a configuration and operation of an end effector control system and an end effector control method according to the present disclosure are specifically disclosed will be described in detail with reference to the drawings as appropriate. It is noted that more detailed description than necessary may be omitted. For example, detailed description of already known matters and overlapped description of substantially the same configurations may be omitted. This is to prevent the following description from being unnecessarily redundant and to help those skilled in the art to easily understand the following description. Note that the attached drawings and the following description are provided for those skilled in the art to fully understand the present disclosure, and are not intended to limit a subject matter recited in the appended claims.

### First Exemplary Embodiment

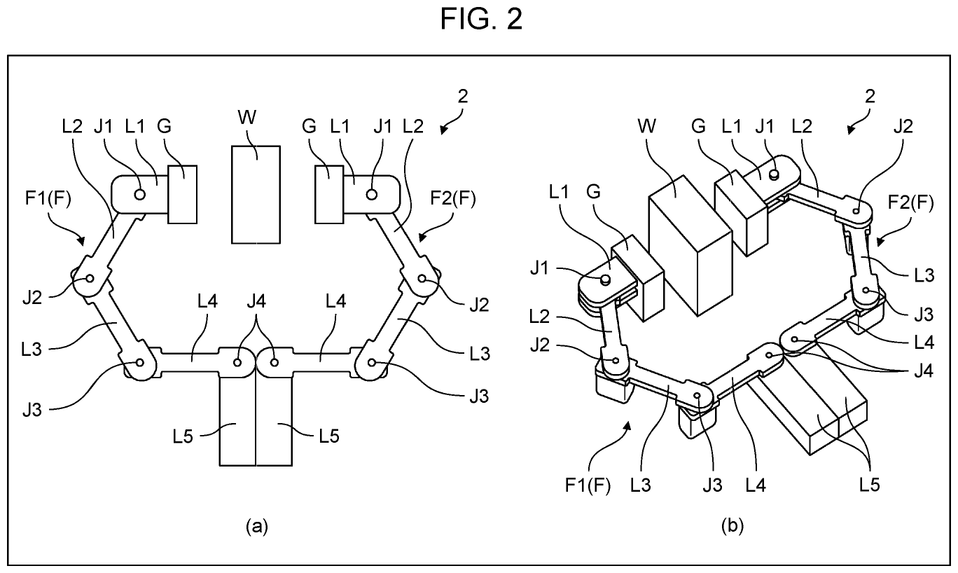

In the following first exemplary embodiment, description will be made on the assumption of a case where a robot hand having two fingers (see FIG. 2) is used as an end effector. The end effector can exhibit various shapes. For example, a workpiece as a work target can be gripped by two (or five, etc.) fingers, or sucked and supported by an adsorbent, or a bent finger can be inserted into a hook provided in the workpiece and hooked. In any case, the end effector supports the workpiece in order to perform some work. Hereinafter, support of a workpiece by such an end effector as shown in FIG. 2 having two fingers may be referred to as “grip”.

### (Configuration Example of Robot Arm 1 and End Effector 2)

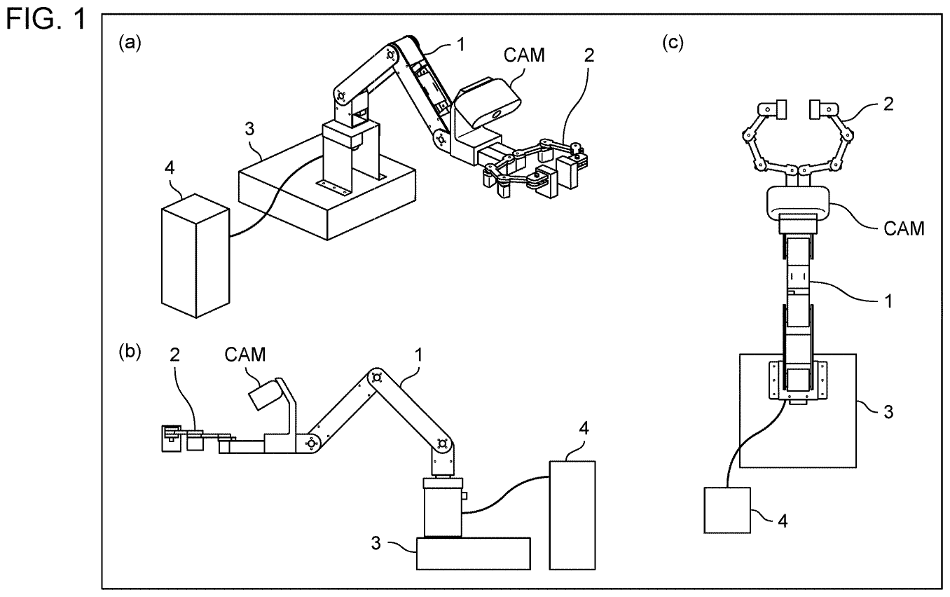

FIG. 1 is a view showing a configuration example of robot arm 1 and end effector 2, the view including (a) a perspective view, (b) a side view, and (c) a plan view. FIG. 2 is a view showing end effector 2 shown in FIG. 1, the view including (a) a plan view and (b) a perspective view. In the following, an example of a robot device controlled by a control system of the present disclosure will be described with reference to these drawings.

The robot device controlled by the control system of the present disclosure includes robot arm 1 and end effector 2. Robot arm 1 is disposed on base 3. In this example, box-shaped controller 4 is connected to end effector 2 via robot arm 1.

End effector 2 is provided with finger F (see FIG. 2). In this example, the finger F is configured with first finger F1 and second finger F2. The number of fingers is, however, not limited to two. Further, as shown in FIG. 1, end effector 2 is provided with camera CAM. Camera CAM will be described later.

As shown in FIG. 2, in this example, first finger F1 has five links. Specifically, first link L1, second link L2, third link L3, fourth link L4, and fifth link L5 are provided in this order from a tip of first finger F1. Further, a joint shaft is provided between the links. Specifically, first joint shaft J1 connects first link L1 and second link L2, second joint shaft J2 connects second link L2 and third link L3, third joint shaft J3 connects third link L3 and fourth link L4, and fourth joint shaft J4 connects fourth link L4 and fifth link L5. In this example, second finger F2 also has the same configuration as first finger F1.

First finger F1 and second finger F2 each have a grip part G at a tip of first link L1. Further, FIG. 1 and FIG. 2 exemplify workpiece W which is a work target. In the example shown in the figure, workpiece W having a rectangular parallelepiped shape has various sizes, shapes, hardnesses, and weights in practice. In this example, end effector 2, which is a robot hand, supports (grips) workpiece W by sandwiching workpiece W with the two grip parts G provided in first finger F1 and second finger F2.

### (Arrangement and Angle of View of Camera CAM)

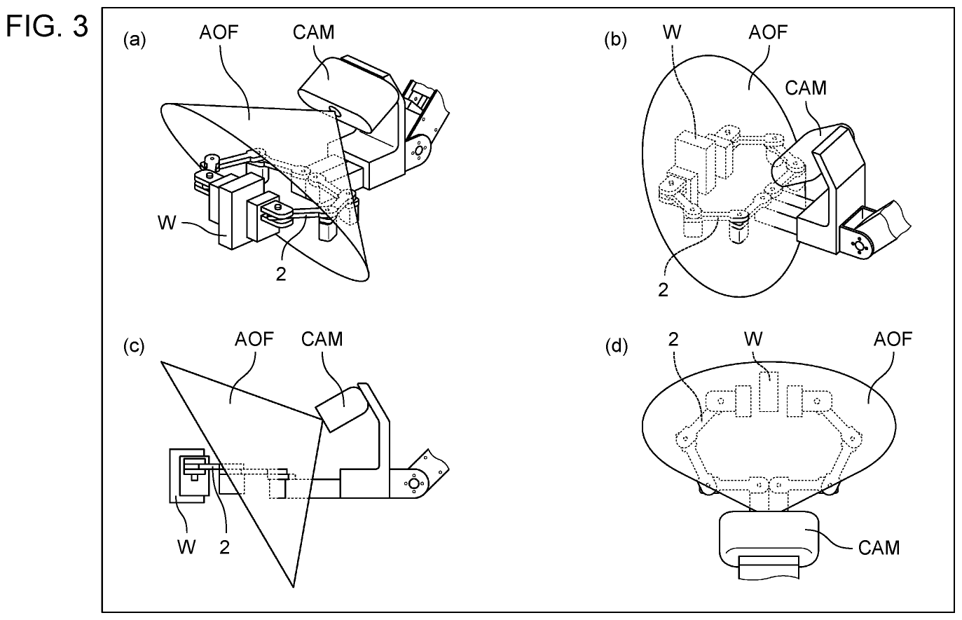

FIG. 3 is a view showing an imaging range of camera CAM connected to end effector 2. A conical region AOF in the figure indicates an angle of view (imaging range) of camera CAM.

As has been already described, the control system of the present disclosure controls end effector 2 based on an image captured by camera CAM without using various sensors such as a force sensor. In order to realize image-based control, camera CAM is disposed near a connection part between end effector 2 and robot arm 1. Further, camera CAM is disposed at a position where end effector 2 and workpiece W which is the work target of end effector 2 can be imaged. Specifically, a shape of end effector 2 and a shape of workpiece W, which is the work target for supporting (gripping), are simultaneously reflected in the image captured by camera CAM.

Although in the example of FIG. 3, camera CAM is disposed near the connection part between end effector 2 and robot arm 1, camera CAM may be disposed in a place other than the connection part.

### (Configuration of Control System)

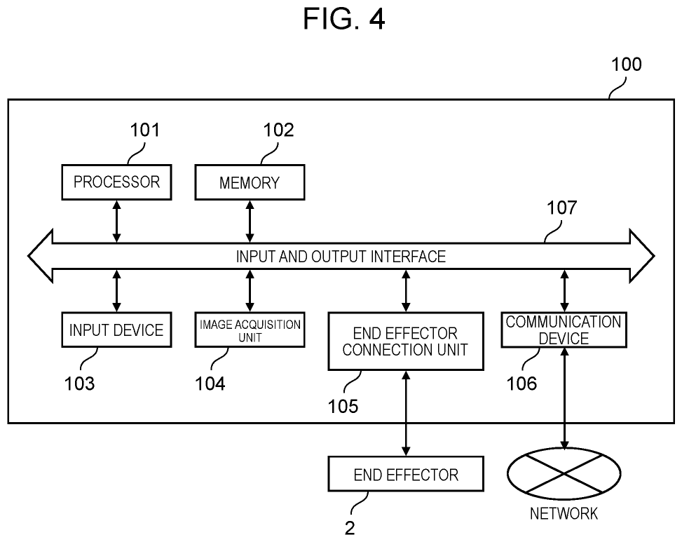

FIG. 4 is a block diagram showing a hardware configuration example of control system 100 according to the first exemplary embodiment. Control system 100 controls operation of robot arm 1 and end effector 2.

Control system 100 in the present example has a configuration including processor 101, memory 102, input device 103, image acquisition unit 104, end effector connection unit 105, communication device 106, and input and output interface 107. Memory 102, input device 103, image acquisition portion 104, end effector connection unit 105, communication device 106, and input and output interface 107 are each connected to processor 101 by an internal bus or the like so as to be capable of inputting and outputting data or information.

Processor 101 is configured with, for example, a central processing unit (CPU), a micro processing unit (MPU), a digital signal processor (DSP), or a field programmable gate array (FPGA). Processor 101 functions as a control unit of control system 100, and performs control processing for comprehensively controlling operation of each unit of control system 100, input and output processing of data or information with each unit of control system 100, data calculation processing, and data or information storage processing. Processor 101 functions also as a control unit that controls end effector 2.

Memory 102 may include an HDD (Hard Disk Drive), a ROM (Read Only Memory), a RAM (Random Access Memory), etc., and stores various programs (operation system (OS), application software, etc.) executed by processor 101 and various data. Further, memory 102 may have control information which is a target position for each end effector. The control information may be, for example, feature point information to be described later.

Input device 103 may include a keyboard, a mouse, and the like, has a function as a human interface with a user, and inputs user's operation. In other words, input device 103 is used for input or instruction in various processing executed by control system 100. Input device 103 may be a programming pendant connected to controller 4.

Image acquisition unit 104 is connectable to camera CAM via wire or by wireless, and acquires an image captured by camera CAM. Control system 100 is capable of appropriately performing image processing on an image acquired by image acquisition unit 104. A core of this image processing may be processor 101. Further, control system 100 may further include an image processing unit (not shown), and the image processing unit may be connected to control system 100. Image processing can be performed by this image processing unit under the control of processor 101.

End effector connection unit 105 is a component that secures the connection with end effector 2 (see also FIG. 1), and control system 100 and end effector 2 (and robot arm 1) are connected via end effector connection unit 105. Although this connection may be wired connection using a connector, a cable, or the like, the connection may be wireless connection. At the time of this connection, end effector connection unit 105 acquires identification information for identifying end effector 2 from end effector 2. In other words, end effector connection unit 105 functions as an identification information acquisition unit. The identification information may be further acquired by processor 101 from end effector connection unit 105. With this identification information, it is possible to specify a type of end effector 2 connected.

Communication device 106 is a component for communicating with the outside via a network. Note that this communication may be wired communication or wireless communication.

Input and output interface 107 has a function as an interface for inputting and outputting data or information with control system 100.

The above configuration of control system 100 is an example, and it is not always necessary to include all the above components. In addition, control system 100 may further include an additional component. For example, box-shaped control system 100 (controller 4) may have wheels, and robot arm 1 and end effector 2 may be mounted on control system 100 to run on its own.

### (Initial Setting Processing)

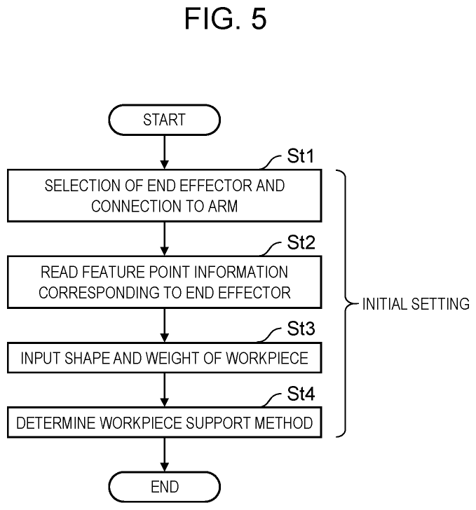

An example of initial setting of control system 100 will be described below. FIG. 5 is a flowchart showing an initial setting example of control system 100. The initial setting is performed before robot arm 1 and end effector 2 are caused to perform predetermined operation.

The robot device performs various operations with various end effectors connected to the robot arm. In addition, the end effectors have various shapes and functions. Therefore, appropriate end effector 2 is selected according to work to be performed on a workpiece, and is connected to robot arm 1 (St1).

Feature point information corresponding to end effector 2 connected is read as control information from memory 102 of control system 100 into a work memory (not shown) or the like of control system 100 (St2). This feature point information may be information in feature point information table T to be described later.

### (Feature Point Information Table T)

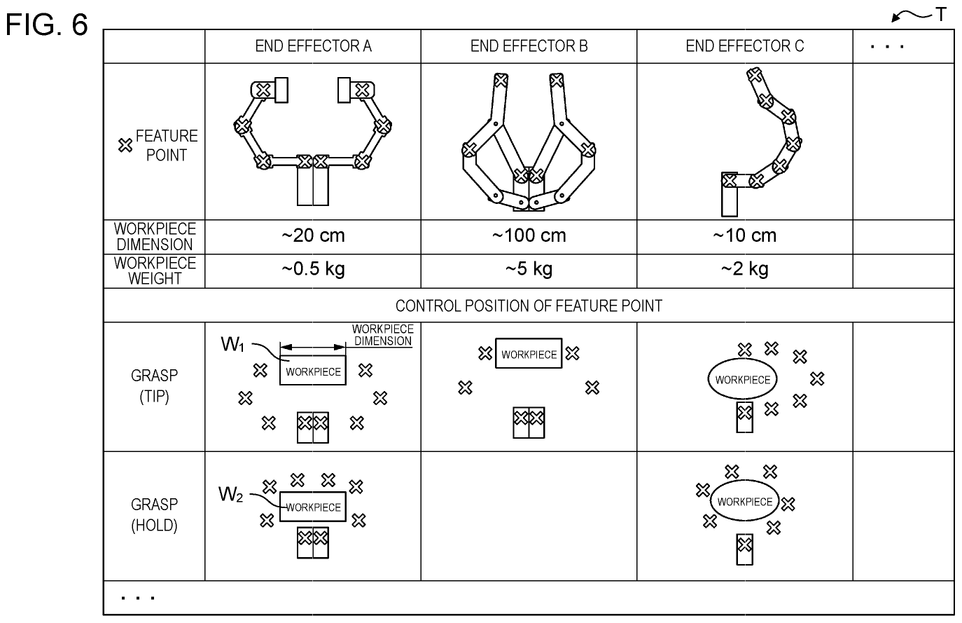

Here, FIG. 6 showing feature point information table T will be referred to. Feature point information table T may be stored in memory 102 of control system 100. In step St2, the feature point information corresponding to end effector 2 included in feature point information table T is extracted from memory 102 and read into the work memory or the like of control system 100.

Feature point information table T has, for example, the following data for each type of end effector (end effectors A to C).

Data item 1: Feature points at a target position of the end effector (feature point information)

Data item 2: Available workpiece dimension

Data item 3: Available workpiece weight

### (Target Position of End Effector)

The end effector performs various operations such as supporting (gripping, etc.) a workpiece and releasing the workpiece. Therefore, there is a target position according to movement, and the end effector is moved (or deformed) to the target position. For example, in order for the end effector to support the workpiece, it is only necessary to move (or deform) the end effector to a support target position of the end effector. In order for the end effector to release (release) the workpiece, the end effector may be moved (or deformed) to the release target position of the end effector.

### (Feature Point)

The control system of the present disclosure controls the end effector based on an image captured by camera CAM. For this processing, one or more feature points on the end effector are specified. In FIG. 6, the feature points are represented by x marks. This feature point may be determined by feature point recognition in a common image recognition technique, or a marker (e.g., a red lamp or the like) may be provided on the end effector and the marker may be used as a feature point.

In the example of feature point information table T shown in FIG. 6, a place where the feature point is disposed is on the joint shaft of the end effector. This is because if the joint shaft can be positioned at a predetermined target position when supporting (gripping) a workpiece, appropriate gripping can be performed. However, the feature point may be disposed on the link of the end effector (e.g., the tip of the link or the like).

Since a shape of the end effector differs depending on its type, the feature points may be disposed at different places for each type of end effector (end effectors A to C). When any of the end effectors A to C is connected to end effector connection unit 105, end effector connection unit 105 acquires the identification information for identifying the end effector as described above, and processor 101 acquires the identification information from end effector connection unit 105 and determines a type (A to C) of the connected end effector.

### (Feature Points at Target Position of End Effector)

For example, the feature points on end effector A in a state where end effector A grasps the workpiece (a state where the end effector is at the target position) shown in FIG. 6 are the feature points at the target position of the end effector. Feature point information table T has the position information of these feature points (feature point information) as the data item 1.

The end effector does not always perform single operation only. Furthermore, the support method can be changed according to a workpiece. For example, for a workpiece having a large dimension, it is preferable to grasp the workpiece with the tip of the finger, and for a workpiece having a small dimension, it is preferable to grasp the workpiece by holding it with the finger. Therefore, feature point information table T may have feature point information separately according to a support method by the end effector (grasping with the tip, grasping so as to be held, etc.).

Based on the foregoing, description will be again returned to the explanation of FIG. 5. For example, in a case where end effector A is connected to robot arm 1 (SW, the feature point information corresponding to end effector A is read into control system 100 as control information in step St2. In this example, feature point information corresponding to each of the plurality of support methods by end effector A (grasping with the tip, grasping so as to be held, etc.) may be collectively read into control system 100.

Subsequently, a shape and a weight of a workpiece are input to control system 100 by input device 103 (St3). Although this input may be performed by a human operator, control system 100 itself may estimate a shape and the like of the workpiece based on an image captured by camera CAM, or the like. This estimation processing may be performed using a common image recognition technique. A measuring apparatus such as a scale may be separately connected to control system 100, and a measured weight may be acquired by control system 100.

Next, control system 100 determines a support method by end effector A (grasping with the tip, grasping so as to be held, etc.) in consideration of the shape and the weight of the workpiece (St4).

By performing the above steps St1 to St4, the initial setting of control system 100 according to the first exemplary embodiment is completed. At the end of the initial setting, control system 100 has already determined the support method by the connected end effector (grasping with the tip, grasping so as to be held, etc.), and also retains the feature point information corresponding to the support method (St2). In other words, a target position of the connected end effector according to the support method is being determined by control system 100 (processor 101).

### (Example of Workpiece Support Control by End Effector 2)

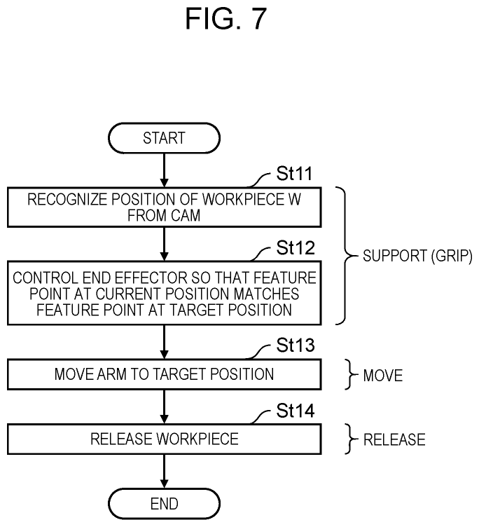

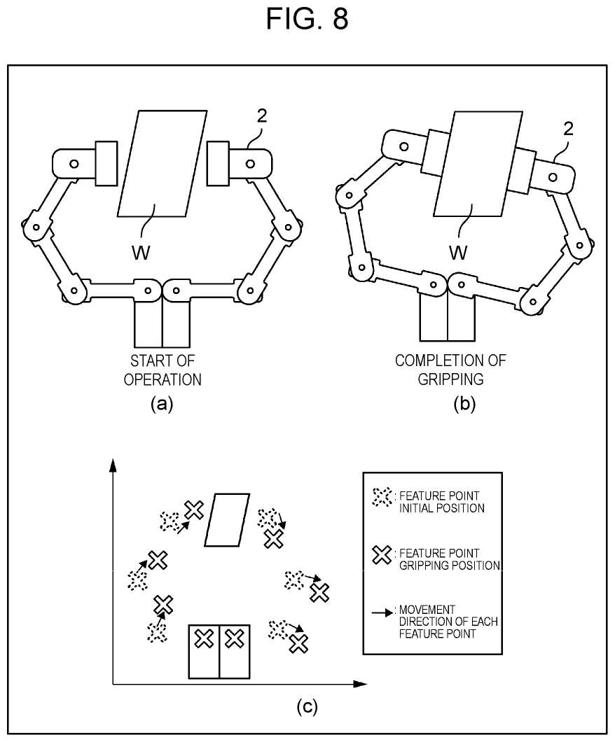

Next, description will be made of a control example in which control system 100 according to the first exemplary embodiment controls support of a workpiece by end effector 2 with reference to FIG. 7 and FIG. 8.

FIG. 7 is a flowchart showing an example in which control system 100 according to the first exemplary embodiment controls support (gripping) of workpiece W by end effector 2. FIG. 8 is a diagram showing a control example of end effector 2 by control system 100 according to the first exemplary embodiment, the diagram including (a) a plan view at the start of operation, (b) a plan view at the completion of gripping, and (c) a conceptual diagram showing drive control of end effector 2 based on feature points. Description will be made on the assumption that workpiece W is moved from one place to another.

First, the prior art may be used for moving robot arm 1 to move end effector 2 to a position where workpiece W can be supported (gripped). Therefore, the state (a) of FIG. 8 in which end effector 2 has been already moved to the position where workpiece W can be supported (gripped) will be described as an initial state.

First, camera CAM captures an image. Image acquisition unit 104 of control system 100 acquires this image. Then, control system 100 recognizes the position of workpiece W to be supported (gripped) based on the image captured by camera CAM (St11). This position recognition may be performed based on a conventional image processing technique.

Next, the end effector is controlled to be located at the target position based on the image acquired by image acquisition unit 104. More specifically, end effector 2 is controlled so that the feature point at the current position of the end effector matches a feature point indicated by the feature point information (a feature point at the target position) (St12). Processing performed in this step St12 will be described in more detail below.

As described above, in the preceding step SW, camera CAM is performing imaging. Here, camera CAM is disposed at a position where end effector 2 and workpiece W, which is a work target of end effector 2, can be imaged (see FIG. 1 and FIG. 3). In other words, both end effector 2 and workpiece W are reflected in the image captured by camera CAM. Control system 100 can specify a feature point at the current position of end effector 2 based on the captured image. The feature points may be specified by feature point recognition by a common image recognition technique, or a marker (e.g., a red lamp or the like) may be provided on end effector 2 and be used as a feature point. For facilitating understanding, the feature point at the current position of end effector 2 is plotted as “feature point initial position” in (c) of FIG. 8.

In addition, due to the initial setting (St1 to St4) described above with reference to FIG. 5 and FIG. 6, control system 100 has already retained feature point information for end effector 2 connected to robot arm 1 according to the support method. The position of the feature point indicated by the feature point information is plotted as “feature point gripping position” in (c) of FIG. 8.

Therefore, at the start of step St12, control system 100 has already specified both the feature point at the current position of end effector 2 and the feature point at the target position of the end effector. Then, in step St12, control system 100 controls end effector 2 such that the feature point (feature point initial position) at the current position of end effector 2 matches the feature point (feature point gripping position) indicated by the feature point information. This control is illustrated in (c) of FIG. 8, and by controlling end effector 2 so that the feature point at the initial position matches the feature point at the gripping position, gripping of workpiece W is completed (see (b) in FIG. 8). Since the position of the feature point of end effector 2 before and after the movement has been already specified, the above control by control system 100 can be performed based on calculation of the inverse kinematics related to end effector 2.

Since the support (gripping) of workpiece W is completed, control system 100 then controls robot arm 1 to move the supported (gripped) workpiece W from one point to another (St13). Subsequently, control system 100 controls end effector 2 so that end effector 2 comes to a target position for release (St14). By this step St14, end effector 2 releases (takes off) the workpiece. In addition, step St14 may be carried out by the same processing as step St12. Specifically, feature point information table T has the feature point information about release of the workpiece, and control system 100 uses this feature point information to control end effector 2 so that the feature point at the current position of end effector 2 matches the feature point indicated by the feature point information.

The release of workpiece W in step St14 does not necessarily have to be performed based on the feature point information. For example, initial positions of each finger and each joint shaft of end effector 2 may be determined in advance, and end effector 2 may be controlled so that the finger and the joint shaft simply return to the initial positions.

### Second Exemplary Embodiment

A second exemplary embodiment of the present disclosure will be described next. Also in the second exemplary embodiment, description will be made on the assumption of a case where a robot hand having two fingers is used as end effector 2. Configuration of robot arm 1 and end effector 2, arrangement of camera CAM, configuration of control system 100, and initial setting processing are the same as those of the first exemplary embodiment, and thus description thereof will be omitted.

The second exemplary embodiment assumes, for example, a case where prior information about workpiece W is insufficient, or a case where workpiece W is made of a soft material. In the case where the prior information about workpiece W is insufficient, it is difficult to accurately specify a target position of end effector 2 in advance. Further, in the case where workpiece W is made of a soft material, workpiece W may be deformed when workpiece W is gripped by a robot hand. Taking this deformation into consideration, it is difficult to control end effector 2 so that end effector 2 appropriately supports workpiece W.

However, control system 100 according to the second exemplary embodiment is capable of performing control so that end effector 2 can appropriately support workpiece W even in the above case.

### (Example of Workpiece Support Control by End Effector 2)

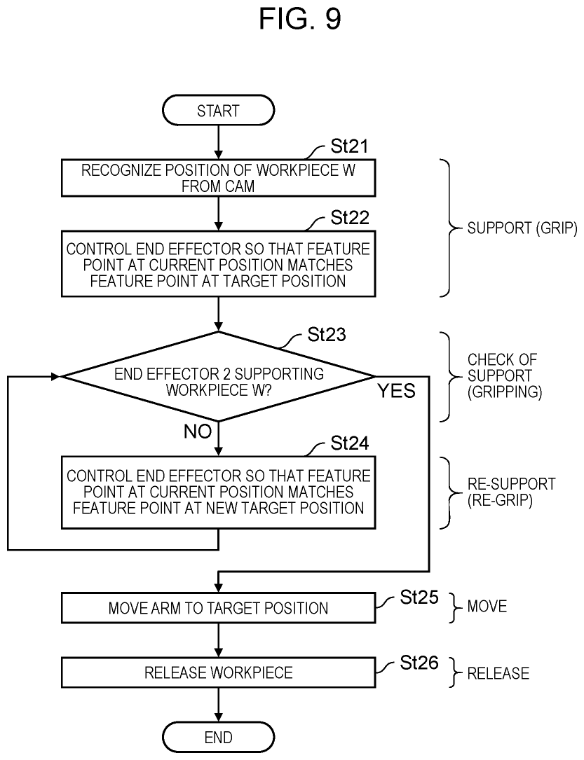

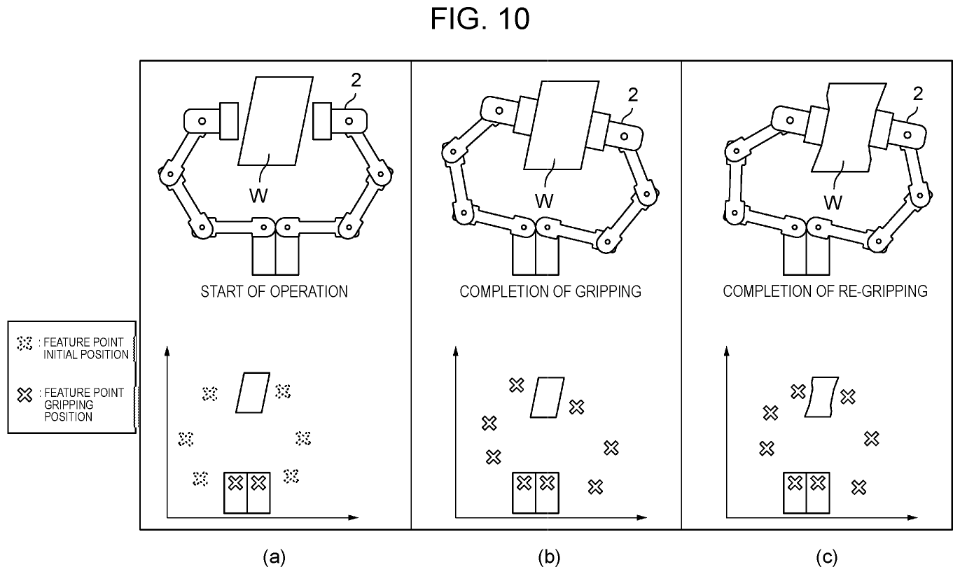

Description will be made of an example in which control system 100 according to the second exemplary embodiment controls support of workpiece W by end effector 2 with reference to FIG. 9 and FIG. 10.

FIG. 9 is a flowchart showing an example in which control system 100 according to the second exemplary embodiment controls support (gripping) of workpiece W by end effector 2. Further, FIG. 10 is a diagram showing a control example of end effector 2 by control system 100 according to the second exemplary embodiment, the diagram including (a) a plan view and a conceptual diagram at the start of operation, (b) a plan view and a conceptual diagram at the completion of gripping, and (c) a plan view and a conceptual diagram at the completion of re-gripping.

As a technique for moving robot arm 1 to move end effector 2 to a position where workpiece W can be supported (gripped), a conventional technique may be used. Therefore, description will be made, as an initial state, of a state (a) of FIG. 10 in which end effector 2 has been already moved to a position where workpiece W can be supported (gripped).

First, camera CAM captures an image. Image acquisition unit 104 of control system 100 acquires this image. Then, control system 100 recognizes the position of workpiece W to be supported (gripped) based on the image captured by camera CAM (St21). This position recognition may be performed based on a conventional image processing technique. The position of end effector 2 and the position of the feature point on end effector 2 at this time are shown in (a) of FIG. 10.

Next, the end effector is controlled to be located at the target position based on the image acquired by image acquisition unit 104. More specifically, end effector 2 is controlled so that the feature point at the current position of the end effector matches the feature point indicated by the feature point information (the feature point at the target position) (St22). This processing is the same as that in step St12 described above according to the first exemplary embodiment.

Specifically, at the start of step St22, control system 100 has been already specified both the feature point at the current position of end effector 2 (according to the image captured by camera CAM) and the feature point at the target position (extracted from feature point information table T in memory 102). Then, in step St22, control system 100 controls end effector 2 so that the feature point at the current position of the end effector matches the feature point indicated by the feature point information. The position of end effector 2 and the position of the feature point on end effector 2 after the processing of step St22 are shown in (b) of FIG. 10.

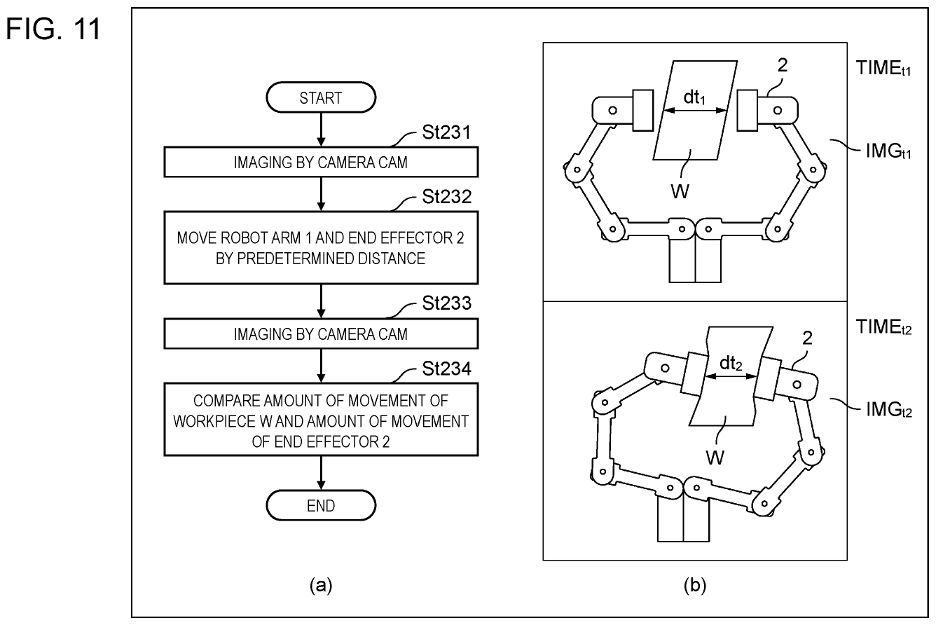

Next, processor 101 checks whether end effector 2 is supporting workpiece W or not (St23). A specific example of this check will be described later with reference to FIG. 11. When end effector 2 is supporting the workpiece (St23, Yes), the processing proceeds to step St25 and step St26 in which the gripped workpiece W is moved and released. Specifically, the processing is as follows.

Control system 100 controls robot arm 1 to move the supported (gripped) workpiece W from one point to another (St25). Subsequently, control system 100 controls a drive unit of end effector 2 so that end effector 2 becomes the target position for release (St26). By this step St26, end effector 2 releases (takes off) the workpiece. In addition, step St26 may be carried out by the same processing as step St22. Specifically, feature point information table T has the feature point information about release of the workpiece, and control system 100 uses this feature point information to control the drive unit of end effector 2 so that the feature point at the current position of end effector 2 matches the feature point indicated by the feature point information.

Further, the release of workpiece W in step St26 does not necessarily have to be performed based on the feature point information. For example, initial positions of each finger and each joint shaft of end effector 2 may be determined in advance, and end effector 2 may be controlled so that the finger and the joint shaft simply return to the initial positions.

Next, the case where in the above-mentioned step St23, end effector 2 is not supporting workpiece W (St23, No) will be described. In the case where there is insufficient prior information about workpiece W, or in the case where workpiece W is made of a soft material, end effector 2 that should have moved correctly in the preceding step St22 could not in practice support (grip) workpiece W. In such a case, the processing makes transition to step St24 for re-supporting (re-gripping) the workpiece.

In step St24, a target position is newly determined from the identification information and the control information, and the end effector is controlled to be located at the new target position based on the image acquired by image acquisition unit 104. More specifically, end effector 2 is controlled based on the image captured by camera CAM such that the feature point at the current position of end effector 2 matches a feature point at the new support target position of end effector 2 based on the position of workpiece W. In other words, since workpiece W could not be supported well at the previous (first) support target position of end effector 2, end effector 2 is moved (deformed) to a new (second) support target position different from the previous one to try to re-support (re-grip) the workpiece.

The feature point at the new support target position may be separately stored as feature point information in feature point information table T described above, and the feature point information may be used for specifying the feature point. Further, processor 101 may dynamically calculate the feature points at the new support target position. For example, information indicating a movement trajectory of each feature point from the start of operation ((a) in FIG. 10) to the completion of gripping ((b) in FIG. 10) is retained in a work memory or the like, and a feature point at a new support target position may be set on an extension line of the trajectory. This new feature point information may be written in feature point information table T at predetermined timing (e.g., timing when the support succeeds). A position of end effector 2 after the processing of step St24 and a position of the feature point on end effector 2 are shown in (c) of FIG. 10.

Next, description will be made of a specific example of check in step St23 in which processor 101 checks whether end effector 2 is supporting workpiece W or not. FIG. 11 is a diagram showing an example of support check in step St23 of FIG. 9, the diagram including (a) a flowchart showing an example of check based on an amount of movement, and (b) a plan view showing an example of check based on deformation of workpiece W.

As shown in (a) of FIG. 11, in step St231, imaging is performed by camera CAM. Image acquisition unit 104 of control system 100 acquires this image. Next, in step St232, control system 100 controls robot arm 1 to move robot arm 1 and end effector 2 by a predetermined distance. Subsequently, in step St233, imaging is performed by camera CAM. Image acquisition unit 104 of control system 100 acquires this image. By the above processing, captured images before and after the movement of workpiece W can be obtained.

Then, in step St234, an amount of movement of workpiece W and an amount of movement of end effector 2 are compared. The amounts of movement can be calculated using the captured images before and after the movement of workpiece W. If end effector 2 could correctly support workpiece W, the amount of movement of end effector 2 should be equal to the amount of movement of workpiece W. On the other hand, in a case where the amount of movement of end effector 2 and the amount of movement of workpiece W are different, it means that end effector 2 is not correctly supporting workpiece W. Accordingly, in step St234, in a case where a difference Dif between the movement amount of workpiece W and the amount of movement of end effector 2 is within a predetermined tolerance value, it can be confirmed that end effector 2 is supporting workpiece W (St23, Yes). On the other hand, in a case where the difference Dif is not within the predetermined tolerance value, it can be confirmed that end effector 2 is not supporting workpiece W (St23, No).

(b) of FIG. 11 shows an example in which the check in step St23 is made based on deformation of workpiece W recognized from the captured image. In this check example, information indicating the deformation of workpiece W is derived by using the images before and after the support of workpiece W by end effector 2. For example, camera CAM captures an image IMGₜ₁ at the start of operation (time t1) and an image IMGₜ₂ at the completion of gripping (time t2), and image acquisition unit 104 of control system 100 acquires these images. Workpiece W at time t2 is compressed and deformed as compared with workpiece W at time t1. The amount of deformation (or deformation rate) is derived by (processor 101 of) control system 100 based on the images IMGₜ₁ and IMGₜ₂, and is used as information indicating the deformation of workpiece W.

For example, in a case where a width of workpiece W at time t1 is dₜ₁ and a width of workpiece W at time t2 is dₜ₂, a deformation rate can be derived by definition of dₜ₂/dₜ₁. This deformation rate can be used as information indicating deformation of workpiece W, and support can be checked based on the information. For example, if 0.9≤dₜ₂/dₜ₁<0.95, it can be checked that end effector 2 is supporting workpiece W, assuming that supporting (gripping) with an appropriate force is performed (St23, Yes). In a case where dₜ₂/dₜ₁<0.9, the support (gripping) force is too strong, and in a case where 0.95≤dₜ₂/dₜ₁, the support (gripping) force is too weak. In each case, it can be confirmed that end effector 2 is not supporting the workpiece W (St23, No). The information indicating the deformation of the workpiece may be information other than the above-mentioned deformation rate, and appropriate information may be used according to a shape, a size, softness, a weight, etc. of workpiece W.

As described in the foregoing, control system 100 of end effector 2 that controls a plurality of end effectors 2 connectable to robot arm 1 includes image acquisition unit 104 that acquires an image of end effector 2, end effector connection unit 105 that acquires identification information that identifies end effector 2, processor 101 that controls end effector 2, and memory 102 having control information which is a target position for each end effector. Processor 101 acquires identification information from end effector connection unit 105, determines a target position in accordance with the identification information and the control information, and controls end effector 2 to be located at the target position based on the image acquired by image acquisition unit 104. This realizes a sensorless and simple system configuration without using a force sensor or the like. Moreover, since it is not necessary to calibrate a plurality of sensors, start-up time of end effector 2 is shortened. Furthermore, by aggregating feedback information from end effector 2 in an image captured by camera CAM, multimodal information processing can be avoided.

Further, processor 101 checks whether or not end effector 2 is supporting workpiece W based on the image acquired by image acquisition unit 104, and in a case where end effector 2 is not supporting workpiece W, newly determines a target position in accordance with the identification information and the control information, and controls end effector 2 to be located at the new target position based on the image acquired by image acquisition unit 104. This facilitates control of support based on flexibility and weight of workpiece W even in a case where there is insufficient prior information about workpiece W, or in a case where workpiece W is made of a soft material. As a result, a range of operation of end effector 2 that supports various workpieces W can be expanded. Further, since it is only necessary to control end effector 2 based on the captured image, a need of calculation is eliminated for the motion law formula in which the flexibility of the workpiece is added to the usual inverse kinematics.

Further, check made by processor 101 as to whether or not end effector 2 is supporting workpiece W is conducted by controlling, by processor 101, end effector 2 so as to move workpiece W, and checking whether or not a difference between an amount of movement of workpiece W and an amount of movement of end effector 2 is within a predetermined tolerance value based on the image acquired by image acquisition unit 104. As a result, it is possible to appropriately check whether or not end effector 2 is supporting workpiece W based on an image captured by camera CAM.

Further, check made by processor 101 as to whether or not end effector 2 is supporting workpiece W is conducted by processor 101 by deriving information indicating deformation of workpiece W based on the image acquired by image acquisition unit 104. As a result, it is possible to appropriately check whether or not end effector 2 is supporting workpiece W based on an image captured by camera CAM.

Further, at least one of the end effectors included in the plurality of end effectors has one or more fingers F, and by grasping workpiece W with a tip of finger F, or by holding workpiece W with finger F, workpiece W is supported. This enables control system 100 to control various support modes of workpiece W by end effector 2.

Further, at least one end effector included in the plurality of end effectors has one or more fingers F each having a plurality of joint shafts, and a feature point of the at least one end effector is disposed on each of one or more joint shafts of each of the one or more fingers F. As a result, the joint shaft can be positioned at a predetermined position at the time of gripping workpiece W.

Further, in a method of controlling a plurality of end effectors 2 connectable to robot arm 1 by control system 100, control system 100 includes image acquisition unit 104, end effector connection unit 105, processor 101, and memory 102. Memory 102 has control information which is a target position for each end effector, image acquisition unit 104 acquires an image of end effector 2, end effector connection unit 105 acquires identification information that identifies end effector 2, and processor 101 acquires the identification information from end effector connection unit 105, and determines a target position in accordance with the identification information and the control information to control end effector 2 to be located at the target position based on an image acquired by image acquisition unit 104. This realizes a sensorless and simple system configuration without using a force sensor or the like. Moreover, since it is not necessary to calibrate a plurality of sensors, start-up time of end effector 2 is shortened. Furthermore, by aggregating feedback information from end effector 2 in an image obtained by camera CAM, multimodal information processing can be avoided.

Further, control system 100 of end effector 2 connected to robot arm 1 includes memory 102, processor 101, and camera CAM, and camera CAM is disposed at a position where end effector 2 and workpiece W which is a work target of end effector 2 can be imaged, memory 102 has feature point information (as e.g., a data item in feature point information table T) indicating a feature point at a first support target position when end effector 2 supports workpiece W, and processor 101 specifies a feature point at a current position of end effector 2 and a position of workpiece W based on an image captured by camera CAM, and controls end effector 2 to be located the feature point at the current position of end effector 2 at the feature point indicated by the feature point information. This realizes a sensorless and simple system configuration without using a force sensor or the like. Moreover, since it is not necessary to calibrate a plurality of sensors, start-up time of end effector 2 is shortened. Furthermore, by aggregating feedback information from end effector 2 in an image captured by camera CAM, multimodal information processing can be avoided.

While various exemplary embodiments have been described in the foregoing with reference to the drawings, it is obvious that the present disclosure is not limited thereto. For those skilled in the art, it is obvious that various modification examples, rectification examples, substitution examples, addition examples, deletion examples, and equivalent examples could be conceived within the scope of claims, and thus it is obviously understood that those examples belong to the technical scope of the present disclosure. Further, the constituent elements in the various exemplary embodiments described above may be combined as needed without departing from the gist of the present invention.

The present disclosure is useful as an end effector control system and an end effector control method enabling an end effector to be controlled while simplifying a robot hand.

What is claimed is:

1. An end effector control system that controls a plurality of end effectors connectable to a robot arm, the end effector control system comprising:
an image acquisition unit that acquires an image of an end effector connected to the robot arm among the plurality of end effectors;
an identification information acquisition unit that acquires identification information that identifies the end effector;
a control unit that controls the end effector; and
a memory having control information including a target position of each of the plurality of end effectors,
wherein the control unit acquires the identification information from the identification information acquisition unit, determines a target position of the end effector in accordance with the identification information and the control information, and controls the end effector to be located at the target position based on the image acquired by the image acquisition unit.

2. The end effector control system according to claim 1, wherein
the control unit checks whether or not the end effector is supporting a workpiece based on the image acquired by the image acquisition unit, and
when the end effector is not supporting the workpiece, determines a new target position of the end effector in accordance with the identification information and the control information, and controls the end effector to be located at the new target position based on the image acquired by the image acquisition unit.

3. The end effector control system according to claim 2, wherein the checking made by the control unit as to whether or not the end effector is supporting the workpiece is conducted by controlling, by the control unit, the end effector so as to move the workpiece, and checking whether or not a difference between an amount of movement of the workpiece and an amount of movement of the end effector is within a predetermined tolerance value based on the image acquired by the image acquisition unit.

4. The end effector control system according to claim 2, wherein the checking made by the control unit as to whether or not the end effector is supporting the workpiece is conducted by deriving, by the control unit, information indicating deformation of the workpiece based on the image acquired by the image acquisition unit.

5. The end effector control system according to claim 1, wherein at least one end effector included in the plurality of end effectors has one or more fingers, and a workpiece is supported by grasping the workpiece with a tip of each of the one or more fingers.

6. The end effector control system according to claim 1, wherein at least one end effector included in the plurality of end effectors has one or more fingers, and a workpiece is supported by holding the workpiece with the one or more fingers.

7. The end effector control system according to claim 1, wherein
at least one end effector included in the plurality of end effectors has one or more fingers each having a plurality of joint shafts, and
a feature point of the at least one end effector is disposed on each of one or more joint shafts among the plurality of joint shafts of each of the one or more fingers.

8. An end effector control method of controlling a plurality of end effectors connectable to a robot arm by a control system including an image acquisition unit, an identification information acquisition unit, and a memory,
the end effector control method comprising:
acquiring identification information that identifies each of the plurality of end effectors from the identification information acquisition unit;
determining a target position of an end effector among the plurality of end effectors in accordance with the identification information and control information which is a target position of each of the plurality of end effectors stored in the memory; and
controlling the end effector to be located at the target position based on an image acquired by the image acquisition unit.

9. An end effector control system for controlling an end effector connected to a robot arm, the end effector control system comprising:
a memory, a processor, and a camera,
wherein
the camera is disposed at a position where the end effector and a workpiece which is a work target of the end effector can be imaged,
the memory has feature point information indicating a feature point at a first support target position when the end effector supports the workpiece, and
the processor specifies a feature point at a current position of the end effector and a position of the workpiece based on an image captured by the camera, and controls the end effector to be located the feature point at the current position of the end effector at the feature point indicated by the feature point information.
